(19) United States
(12) Patent Application Publication
(10) Pub. No.: US 2012/0199729 A1
(43) Pub. Date: Aug. 9, 2012

(54) Device For Measuring Quantity of Substrates

(75) Inventors: Takgyum Kim, Gyeonggi-do (KR); Soowoong Park, Incheon (KR); Changju Lee, Gyeonggi-do (KR)

(73) Assignee: SAMSUNG ELECTRO-MECHANICS CO., LTD., Suwon (KR)

(21) Appl. No.: 13/064,736

(22) Filed: Apr. 12, 2011

(30) Foreign Application Priority Data
Feb. 7, 2011 (KR) 10-2011-0010635

(51) Int. Cl. G06M 9/00; G01J 1/58

(52) U.S. Cl. 250/224; 250/458.1

(57) ABSTRACT

Provided is a device for measuring the quantity of substrates including: a scan unit which generates a signal beam for measuring the quantity of a plurality of laminated substrates from a substrate laminate by scanning the substrate laminate with laser along a lamination direction of the substrates on a side surface of the substrate laminate formed by laminating the plurality of substrates; and a detection unit which detects the quantity of the plurality of laminated substrates by receiving the signal beam.

According to the present invention, it is possible to reduce manufacturing costs and improve productivity through simplification of a manufacturing process and reduction of process time by automatically measuring the quantity of the plurality of laminated substrates to improve inefficiency of an existing process of measuring the quantity of substrates through a manual operation.

### CROSS-REFERENCE TO RELATED APPLICATIONS

This application claims the benefit under 35 U.S.C. Section 119 of Korean Patent Application Serial No. 10-2011-0010635, filed Feb. 7, 2011, which is hereby incorporated by reference in its entirety into this application.

### BACKGROUND OF THE INVENTION

1. Field of the Invention

The present invention relates to a device for measuring the quantity of substrates, and more particularly, to a device for measuring the quantity of substrates capable of reducing manufacturing costs and improving productivity by automatically measuring the quantity of substrates of a substrate laminate formed by laminating a plurality of substrates to improve efficiency of a process of measuring the quantity of substrates.

2. Description of the Related Art

In general, a substrate such as a printed circuit board is manufactured into one finished product through various processes.

In the manufacturing process of the substrate, a firstly input material is a copper clad laminate. The copper clad laminate means a copper (Cu) clad thin laminate.

A general structure of the copper clad laminate consists of “copper foil/insulating layer/copper coil”. The substrate is manufactured by cleaning the copper clad laminate, laminating a dry film, removing a portion of the dry film through exposure and development, etching a copper plating layer of the opened portion, stripping the dry film, and forming a circuit.

Meanwhile, an operation of checking the quantity of substrates is essentially necessary for several processes of the substrate. That is, it is necessary to check the quantity of substrates output after the process in comparison with the quantity of substrates input into the process.

However, when there is no device for automatically measuring the quantity of substrates, an operator directly checks the quantity of substrates during the process of the substrate.

In this case, since the operator directly manually counts the quantity of substrates, there are problems such as high operator fatigue, lower efficiency than other operations, high labor cost, and high production cost due to long measurement time.

Further, since the substrate is likely to be bent or scratched and foreign materials are inserted in the substrate while the operator manually counts the quantity of substrates, there is a problem such as a reduction in productivity due to substrate failure during the manufacturing process of the substrate.

### SUMMARY OF THE INVENTION

The present invention has been invented in order to overcome the above-described problems and it is, therefore, an object of the present invention to provide capable of reducing manufacturing costs and improving productivity by automatically measuring the quantity of substrates of a substrate laminate formed by laminating a plurality of substrates to improve efficiency of a process of measuring the quantity of substrates.

In accordance with one aspect of the present invention to achieve the object, there is provided a device for measuring the quantity of substrates including: a scan unit which generates a signal beam for measuring the quantity of a plurality of laminated substrates from a substrate laminate by scanning the substrate laminate with laser along a lamination direction of the substrates on a side surface of the substrate laminate formed by laminating the plurality of substrates; and a detection unit which detects the quantity of the plurality of laminated substrates by receiving the signal beam.

Here, the substrate laminate may be formed by laminating the plurality of substrates including resin layers and the resin layer of each substrate may be exposed to a side surface of the substrate so that the signal beam generated from the substrate laminate during the laser scanning by the scan unit may be a fluorescence beam.

Accordingly, the scan unit may include a laser beam irradiator which emits a laser beam for the laser scanning and a scanner which scans the substrate laminate with laser by receiving the laser beam and emitting the laser beam to the substrate laminate and emits the fluorescence beam to the detection unit by receiving the fluorescence beam generated from the substrate laminate during the laser scanning.

At this time, the detection unit may include a first detector which measures the quantity of the plurality of laminated substrates by receiving the fluorescence beam emitted from the scanner and detecting a fluorescence signal corresponding to the fluorescence beam.

And the device for measuring the quantity of substrates may include a laser transmission mirror and a total reflection mirror which are sequentially disposed between the laser beam irradiator and the scanner along an irradiation direction of the laser beam in order to guide the laser beam emitted from the laser beam irradiator to the scanner and guide the fluorescence beam emitted from the scanner to the first detector. At this time, the first detector may be disposed at one side of the laser transmission mirror to receive the fluorescence beam reflected by the laser transmission mirror.

Meanwhile, the substrate laminate may be formed by laminating a plurality of substrates having plated side surfaces so that the signal beam generated from the substrate laminate during the laser scanning by the scan unit may be a reflected beam.

Accordingly, the scan unit may include a laser beam irradiator which emits a laser beam for the laser scanning and a scanner which scans the substrate laminate with laser by receiving the laser beam and emitting the laser beam to the substrate laminate and emits the reflected beam to the detection unit by receiving the reflected beam reflected from the substrate laminate during the laser scanning.

At this time, the detection unit may include a second detector which measures the quantity of the plurality of laminated substrates by receiving the reflected beam emitted from the scanner and detecting a reflected beam signal corresponding to the reflected beam.

And the device for measuring the quantity of substrates may include a laser beam splitter and a total reflection mirror which are sequentially disposed between the laser beam irradiator and the scanner along an irradiation direction of the laser beam in order to guide the laser beam emitted from the laser beam irradiator to the scanner and guide the reflected beam emitted from the scanner to the second detector. At this time, the second detector may be disposed at one side of the laser beam splitter to receive the reflected beam reflected by the laser beam splitter.

Meanwhile, the scan unit may further include a lens which is disposed at an emission side of the scanner and allows the laser beam emitted from the scanner to be uniformly emitted in a direction perpendicular to the side surface of the substrate laminate.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a configuration diagram roughly showing a first embodiment of a device for measuring the quantity of substrates in accordance with the present invention;

FIG. 2 is a graph roughly showing a fluorescence signal of a substrate laminate detected by a first detector of FIG. 1;

FIG. 3 is a configuration diagram roughly showing a second embodiment of a device for measuring the quantity of substrates in accordance with the present invention;

FIG. 4 is a graph roughly showing a fluorescence signal of a substrate laminate detected by a second detector of FIG. 3; and

FIG. 5 is a configuration diagram roughly showing a third embodiment of a device for measuring the quantity of substrates in accordance with the present invention.

### DETAILED DESCRIPTION OF THE PREFERABLE EMBODIMENTS

A matter regarding to an operation effect including a technical configuration for an object of a device for measuring the quantity of substrates in accordance with the present invention to achieve the object will be clearly appreciated through the following detailed description with reference to the accompanying drawings illustrating preferable embodiments of the present invention.

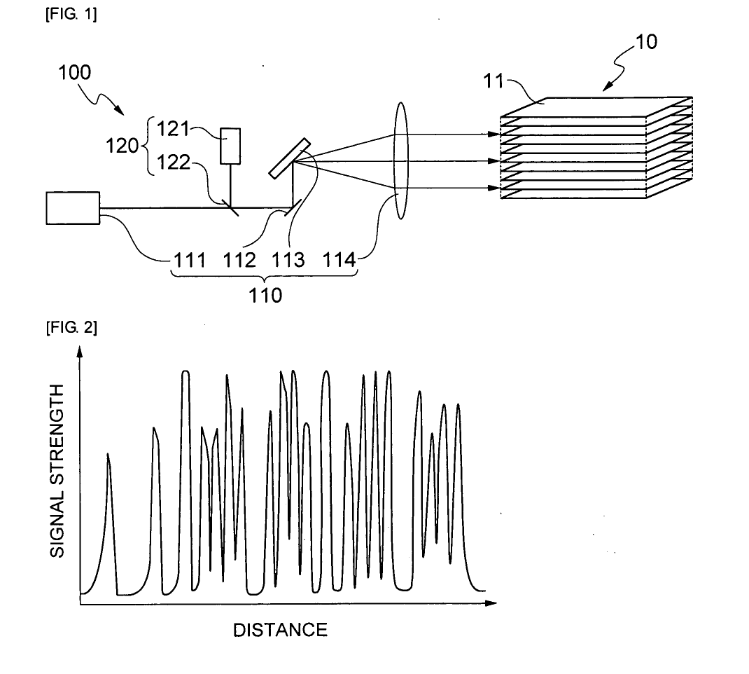

First, FIG. 1 is a configuration diagram roughly showing a first embodiment of a device for measuring the quantity of substrates in accordance with the present invention, and FIG. 2 is a graph roughly showing a fluorescence signal of a substrate laminate detected by a first detector of FIG. 1.

Referring to FIG. 1, a device 100 for measuring the quantity of substrates in accordance with a first embodiment of the present invention includes a scan unit 110 and a detection unit 120.

The scan unit 110 generates a signal beam for measuring the quantity of a plurality of laminated substrates 11 from a substrate laminate 10 by scanning the substrate laminate 10 with laser along a lamination direction of the substrates 11 on a side surface of the substrate laminate 10 formed by laminating the plurality of substrates 11.

The detection unit 120 detects the quantity of the plurality of laminated substrates 11 by receiving the signal beam generated from the substrate laminate 10.

Here, the substrate laminate 10 may be formed by laminating the plurality of substrates 11 including resin layers, and the resin layer of each substrate 11 may be exposed to a side surface of the substrate. Accordingly, the signal beam generated from the substrate laminate 10 during the laser scanning by the scan unit 110 may be a fluorescence beam.

That is, the fluorescence beam is generated from the resin layer of each substrate 11 when laser is irradiated to each substrate 11 of the substrate laminate 10 during the laser scanning of the substrate laminate 10 by the scan unit 110. At this time, the detection unit 120 can measure the quantity of the plurality of laminated substrates 11 by receiving the fluorescence beam and detecting a fluorescence signal corresponding to the fluorescence beam.

More specifically, the scan unit 110 may include a laser beam irradiator 111 which emits a laser beam for the laser scanning and a scanner 113 which scans the substrate laminate 10 with laser by receiving the emitted laser beam and emits the laser beam to the substrate laminate 10 and emits the fluorescence beam to the detection unit 120 by receiving the fluorescence beam generated from the substrate laminate 10 during the laser scanning.

At this time, the detection unit 120 may include a first detector 121 which measures the quantity of the plurality of laminated substrates 11 by receiving the fluorescence beam emitted from the scanner 113 and detecting the fluorescence signal corresponding to the fluorescence beam.

Here, the device 100 for measuring the quantity of substrates may include a laser transmission mirror 122 and a total reflection mirror 112 which are sequentially disposed between the laser beam irradiator 111 and the scanner 113 along an irradiation direction of the laser beam in order to guide the laser beam emitted from the laser beam irradiator 111 to the scanner 113 and guide the fluorescence beam emitted from the scanner 113 to the first detector 121. At this time, the first detector 121 may be disposed at one side of the laser transmission mirror 122 and measure the quantity of substrates 11 of the substrate laminate 10 by receiving the fluorescence beam reflected by the laser transmission mirror 122 and detecting the fluorescence signal corresponding to the fluorescence beam.

And the device 100 for measuring the quantity of substrates in accordance with the present embodiment may further include a lens 114 which is disposed at an emission side of the scanner 113 and allows the laser beam emitted from the scanner 113 to be uniformly emitted in a direction perpendicular to a side lamination direction of the substrate laminate 10.

A process of measuring the quantity of substrates of the substrate laminate 10 by the scan unit 110 and the detection unit 120 configured as above is as follows.

First, the laser beam emitted from the laser beam irradiator 111 transmits the laser transmission mirror 122, the laser beam transmitting through the laser transmission mirror 122 is reflected by the total reflection mirror 112 to be incident on the scanner 113, and the scanner 113 scans the substrate laminate 10 with laser along a lamination direction of the substrates 11 while emitting the incident laser beam to the substrate laminate 10.

Here, the laser beam emitted through the scanner 113 is uniformly emitted in the direction perpendicular to the side lamination direction of the substrate laminate 10 through the laser 114 and thus it is possible to improve laser beam irradiation efficiency from the scanner 113 to the substrate laminate 10.

And the fluorescence beam is generated through the resin layer of each substrate 11 by irradiating laser to each substrate 11 of the substrate laminate 10 during the laser scanning of the substrate laminate 10 by the scanner 113. The fluorescence beam is incident on the scanner 113 through the lens 114, and the scanner 113 emits the incident fluorescence beam to the total reflection mirror 112.

Further, the fluorescence beam emitted through the scanner 113 is reflected by the total reflection mirror 112 to be emitted to the laser transmission mirror 122, and the fluorescence beam emitted to the laser transmission mirror 122 is reflected by the laser transmission mirror 122 to be incident on the first detector 121. At this time, the laser transmission mirror 122 may have a characteristic that it totally transmits the laser beam and reflects beams other than the laser beam.

Like this, when the fluorescence beam is incident on the first detector 121, the first detector 121 can detect the fluorescence signal corresponding to the incident fluorescence beam.

That is, as shown in FIG. 2, the first detector 121 can detect signal strength of the fluorescence signal with respect to a scan distance along a lamination direction of the substrates during the laser scanning of the substrate laminate 10. At this time, it is possible to measure the quantity of substrates of the substrate laminate 10 by detecting a peak point of the detected fluorescence signal.

In other words, the peak point of the fluorescence signal is detected by the first detector 121 when the laser beam is irradiated to the resin layer of each substrate 11 during the laser scanning of the substrate laminate 10. That is, the peak point of the fluorescence signal corresponds to the signal corresponding to the resin layer of one substrate. Accordingly, it is possible to measure the quantity of substrates of the substrate laminate 10 by calculating the number of peak points of the fluorescence signal detected by the first detector 121.

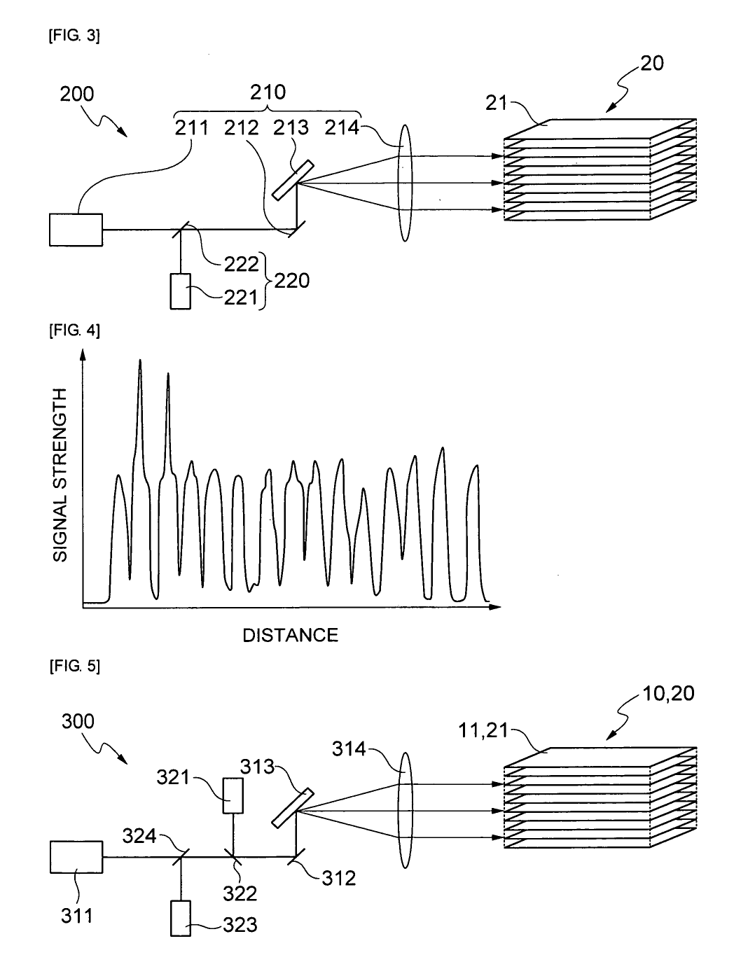

Next, FIG. 3 is a configuration diagram roughly showing a second embodiment of a device for measuring the quantity of substrates in accordance with the present invention, and FIG. 4 is a graph roughly showing a fluorescence signal of a substrate laminate detected by a second detector of FIG. 3. Referring to FIG. 3, a device 200 for measuring the quantity of substrates in accordance with a second embodiment of the present invention is for measuring the quantity of substrates of a substrate laminate 20 when the substrate laminate 20 is formed by laminating a plurality of substrates 21 having side surfaces plated with a metal such as copper.

That is, the device 200 for measuring the quantity of substrates in accordance with the present embodiment is applied when it is impossible to measure the quantity of substrates by detection of a fluorescence signal since the side surfaces of each substrate 21 constituting the substrate laminate 20 are plated with a metal such as copper and thus a fluorescence beam is not generated during laser scanning of the substrate laminate 20.

Accordingly, the device 200 for measuring the quantity of substrates in accordance with the present embodiment measures the quantity of substrates of the substrate laminate 20 by irradiating laser to the side surface of each substrate 21 of the substrate laminate 20 and detecting a reflected beam reflected from the side surface of each substrate 21 of the substrate laminate 20 during the laser scanning of the substrate laminate 20.

More specifically, the device 200 for measuring the quantity of substrates in accordance with the present embodiment includes a scan unit 210 and a detection unit 220. The scan unit 210 generates a signal beam, that is, the reflected beam as described above, for measuring the quantity of the plurality of laminated substrates 21 from the substrate laminate 20 by scanning the substrate laminate 20 with laser along a lamination direction of the substrates 21 on a side surface of the substrate laminate 20 formed by laminating the plurality of substrates 21. The detection unit 220 detects the quantity of the plurality of laminated substrates 21 by receiving the reflected beam generated from the substrate laminate 20.

That is, in the present embodiment, when the substrate laminate 20 is laser-scanned by the scan unit 210, the laser beam emitted to the side surface of each substrate 21 of the substrate laminate 20 is reflected from the plated side surface of each substrate 21 to generate the reflected beam. The detection unit 220 measures the quantity of the plurality of laminated substrates 21 by receiving the reflected beam and detecting a reflected beam signal corresponding to the reflected beam.

Here, the scan unit 210 may include a laser beam irradiator 211 which emits the laser beam for the laser scanning and a scanner 213 which scans the substrate laminate 20 with laser by receiving the emitted laser beam and emitting the laser beam to the substrate laminate 20 and emits the reflected beam to the detection unit 220 by receiving the reflected beam generated from the substrate laminate 20 during the laser scanning.

At this time, the detection unit 220 may include a second detector 221 which measures the quantity of the plurality of laminated substrates 21 by receiving the reflected beam emitted from the scanner 213 and detecting the reflected beam signal corresponding to the reflected beam.

Here, the device 200 for measuring the quantity of substrates in accordance with the present embodiment may include a beam splitter 222 and a total reflection mirror 212 which are sequentially disposed between the laser beam irradiator 211 and the scanner 213 along an irradiation direction of the laser beam in order to guide the laser beam emitted from the laser beam irradiator 211 to the scanner 213 and guide the reflected beam emitted from the scanner 213 to the second detector 221. At this time, the second detector 221 may be disposed at one side of the beam splitter 222 and measure the quantity of substrates of the substrate laminate 20 by receiving the reflected beam reflected by the beam splitter 222 and detecting the reflected beam signal corresponding to the reflected beam.

And the device 200 for measuring the quantity of substrates in accordance with the present embodiment may further include a lens 214 which is disposed at an emission side of the scanner 213 and allows the laser beam emitted from the scanner 213 to be uniformly emitted in a direction perpendicular to a side lamination direction of the substrate laminate 20.

A process of measuring the quantity of substrates of the substrate laminate 20 by the scan unit 210 and the detection unit 220 configured as above is as follows.

First, the laser beam emitted from the laser beam irradiator 211 partially transmits the beam splitter 222, the laser beam transmitting through the beam splitter 222 is reflected by the total reflection mirror 212 to be incident on the scanner 213, and the scanner 213 scans the substrate laminate 20 with laser along a lamination direction of the substrates 21 while emitting the incident laser beam to the substrate laminate 20.

Here, the laser beam emitted through the scanner 213 is uniformly emitted in the direction perpendicular to the side lamination direction of the substrate laminate 20 through the lens 214 and thus it is possible to improve laser beam irradiation efficiency from the scanner 213 to the substrate laminate 20.

And the reflected beam is generated from the plated side surface of each substrate 21 by irradiating laser to each substrate 21 of the substrate laminate 20 during the laser scanning of the substrate laminate 20 by the scanner 213. The reflected beam is incident on the scanner 213 through the lens 214, and the scanner 213 emits the incident reflected beam to the total reflection mirror 212.

Further, the reflected beam emitted through the scanner 213 is reflected by the total reflection mirror 212 to be emitted to the beam splitter 222, and about 50% of the reflected beam emitted to the beam splitter 222 is reflected by the beam splitter 222 to be incident on the second detector 221. That is, the beam splitter 222 may have a characteristic that it transmits about 50% of the laser beam and reflects the remaining 50% of the laser beam.

Like this, when the reflected beam is incident on the second detector 221, the second detector 221 can detect the reflected beam signal corresponding to the incident reflected beam.

That is, as shown in FIG. 4, the second detector 221 can detect signal strength of the reflected beam signal with respect to a scan distance along the lamination direction of the substrates 21 during the laser scanning of the substrate laminate 20. At this time, it is possible to measure the quantity of substrates of the substrate laminate 20 by detecting a peak point of the detected reflected beam signal.

In other words, the peak point of the reflected beam signal is detected by the second detector 221 when the laser beam is irradiated to the plated side surface of each substrate 21 during the laser scanning of the substrate laminate 20. That is, the peak point of the reflected beam signal corresponds to the signal corresponding to the plated side surface of one substrate. Accordingly, it is possible to measure the quantity of substrates of the substrate laminate 20 by calculating the number of peak points of the reflected beam signal detected by the second detector 221.

Next, FIG. 5 is a configuration diagram roughly showing a third embodiment of a device for measuring the quantity of substrates in accordance with the present invention. As shown in FIG. 5, a device 300 for measuring the quantity of substrates in accordance with the present embodiment is a device formed by combining the device for measuring the quantity of substrates of the above-described first embodiment and the device for measuring the quantity of substrates of the above-described second embodiment. Accordingly, the device 300 for measuring the quantity of substrates of the present embodiment can be applied to both of the substrate laminate 10 having a structure in which the resin layer of each substrate 11 is exposed to the side surface of the substrate and the substrate laminate 20 having a structure in which the side surface of each substrate 21 is plated with a metal such as copper.

That is, the device 300 for measuring the quantity of substrates in accordance with the present embodiment may include a laser beam irradiator 311, a total reflection mirror 312, a scanner 313, a lens 314, a first detector 321, a laser transmission mirror 322, a second detector 323, and a beam splitter 324. Since structures, operations, and effects of the above components are equal to those of the device for measuring the quantity of substrates of the above-described first embodiment and those of the device for measuring the quantity of substrates of the above-described second embodiment except reference numerals, detailed descriptions thereof will be omitted.

For reference, when the substrate constituting the substrate laminate for measuring the quantity of substrates is a substrate of which a resin layer is exposed to a side surface, it is possible to measure the quantity of substrates of the substrate laminate through the same process as the above-described first embodiment by using the remaining components except the second detector. When the substrate constituting the substrate laminate for measuring the quantity of substrates is a substrate of which a side surface is plated with a metal, it is possible to measure the quantity of substrates of the substrate laminate through the same process as the above-described second embodiment by using the remaining components except the first detector.

The device for measuring the quantity of substrates in accordance with the present invention has the following effects.

According to the device for measuring the quantity of substrates of the present invention, it is possible to improve efficiency of a process of measuring the quantity of substrates by rapidly, accurately, and automatically measuring the quantity of substrates of the substrate laminate formed by laminating the plurality of substrates through laser scanning.

Further, according to the device for measuring the quantity of substrates of the present invention, it is possible to reduce manufacturing costs and improve product reliability and productivity by improving speed, accuracy, and convenience of measurement of the quantity of substrates.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

1. A device for measuring the quantity of substrates comprising:
a scan unit which generates a signal beam for measuring the quantity of a plurality of laminated substrates from a substrate laminate by scanning the substrate laminate with laser along a lamination direction of the substrates on a side surface of the substrate laminate formed by laminating the plurality of substrates; and
a detection unit which detects the quantity of the plurality of laminated substrates by receiving the signal beam.

2. The device for measuring the quantity of substrates according to claim 1, wherein the substrate laminate is formed by laminating the plurality of substrates including resin layers and the resin layer of each substrate is exposed to a side surface of the substrate so that the signal beam generated from the substrate laminate during the laser scanning by the scan unit is a fluorescence beam.

3. The device for measuring the quantity of substrates according to claim 2, wherein the scan unit comprises:
a laser beam irradiator which emits a laser beam for the laser scanning; and
a scanner which scans the substrate laminate with laser by receiving the laser beam and emitting the laser beam to the substrate laminate and emits the fluorescence beam to the detection unit by receiving the fluorescence beam generated from the substrate laminate during the laser scanning, and the detection unit comprises;
a first detector which measures the quantity of the plurality of laminated substrates by receiving the fluorescence beam emitted from the scanner and detecting a fluorescence signal corresponding to the fluorescence beam.

4. The device for measuring the quantity of substrates according to claim 3, further comprising:
a laser transmission mirror and a total reflection mirror which are sequentially disposed between the laser beam irradiator and the scanner along an irradiation direction of the laser beam in order to guide the laser beam emitted from the laser beam irradiator to the scanner and guide the fluorescence beam emitted from the scanner to the first detector, wherein the first detector is disposed at one side of the laser transmission mirror to receive the fluorescence beam reflected by the laser transmission mirror.

5. The device for measuring the quantity of substrates according to claim 1, wherein the substrate laminate is formed by laminating a plurality of substrates having plated side surfaces so that the signal beam generated from the substrate laminate during the laser scanning by the scan unit is a reflected beam.

6. The device for measuring the quantity of substrates according to claim 5, wherein the scan unit comprises:
a laser beam irradiator which emits a laser beam for the laser scanning; and
a scanner which scans the substrate laminate with laser by receiving the laser beam and emitting the laser beam to the substrate laminate and emits the reflected beam to the detection unit by receiving the reflected beam reflected from the substrate laminate during the laser scanning, and the detection unit comprises:
a second detector which measures the quantity of the plurality of laminated substrates by receiving the reflected beam emitted from the scanner and detecting a reflected beam signal corresponding to the reflected beam.

7. The device for measuring the quantity of substrates according to claim 6, further comprising:
a laser beam splitter and a total reflection mirror which are sequentially disposed between the laser beam irradiator and the scanner along an irradiation direction of the laser beam in order to guide the laser beam emitted from the laser beam irradiator to the scanner and guide the reflected beam emitted from the scanner to the second detector, wherein the second detector is disposed at one side of the laser beam splitter to receive the reflected beam reflected by the laser beam splitter.

8. The device for measuring the quantity of substrates according to claim 3, further comprising:
a lens which is disposed at an emission side of the scanner and allows the laser beam emitted from the scanner to be uniformly emitted in a direction perpendicular to the side surface of the substrate laminate.

9. The device for measuring the quantity of substrates according to claim 6, further comprising:
a lens which is disposed at an emission side of the scanner and allows the laser beam emitted from the scanner to be uniformly emitted in a direction perpendicular to the side surface of the substrate laminate.
